(19) United States
(12) Patent Application Publication
(10) Pub. No.: US 2017/0210415 A1
(43) Pub. Date: Jul. 27, 2017

(54) PROVIDING OSCILLATORY FEEDBACK THROUGH A VEHICLE STEERING SYSTEM

(71) Applicant: Jaguar Land Rover Limited, Whitley, Coventry, Warwickshire (GB)

(72) Inventors: Anthony WHITTLE, Nuneaton, Warwickshire (GB); David LICKFOLD, Leamington Spa, Warwickshire (GB); John KEWLEY, Leamington Spa, Warwickshire (GB); Nick TEMPLE, Coventry, West Midlands (GB)

(21) Appl. No.: 15/315,343

(22) PCT Filed: May 29, 2015
(86) PCT No.: PCT/EP2015/062033

§ 371 Date: Nov. 30, 2016

Related U.S. Application Data
(63) Continuation-in-part of application No. 14/291,934, filed on May 30, 2014, now Pat. No. 9,308,933.

(51) Int. Cl. B62D 6/00; B62D 5/04

(52) U.S. Cl. CPC B62D 6/008; B62D 5/0457

(57) ABSTRACT

A method for controlling the provision of oscillatory feedback through a steering system of a vehicle. The method comprises receiving a request to provide oscillatory feedback through the steering system of the vehicle. The method further comprises determining a characteristic of a road surface being traversed by the vehicle. The method still further comprises imparting to a component of the steering system an oscillating force having one or more oscillation properties that is/are dependent upon the determined road surface characteristic to thereby provide the requested oscillatory feedback.

### TECHNICAL FIELD

This present disclosure relates to oscillatory feedback provided through the steering of a vehicle and particularly, but not exclusively, to taking into account characteristic(s) of the road surface being traversed by the vehicle in the provision of such oscillatory feedback. Aspects of the invention relate to a method, to a non-transitory computer-readable storage medium, to a system, to an electronic controller, to a vehicle, to a vehicle steering system, and to an electric power assisted steering (EPAS) system.

### BACKGROUND

Various means are known in the art for providing feedback to drivers of motor vehicles about the state of the vehicle and/or its surroundings. For instance, feedback may be used to warn drivers when one or more particular defined conditions exist, such as, for example, when the vehicle is departing from the lane in which it is travelling or it is detected that a driver is drowsy.

This feedback may take any number of forms, one being oscillatory feedback. Oscillatory feedback, which may include, for example, haptic (e.g., tactile vibration) and/or audible feedback, has been found to be effective in providing warnings to drivers when certain defined conditions exist. Oscillatory feedback may be delivered in a number of ways. One way is via a vehicle's steering input device, e.g., steering wheel. In particular, the steering wheel may be caused to vibrate to provide a warning to be sensed by the driver's hands. It is known to provide vibrations with dedicated vibration means, such as an electric motor and imbalance, within the steering wheel or within the steering column; however, the additional components add weight and complexity to the vehicle.

While providing oscillatory feedback certainly serves an important purpose of warning drivers that certain conditions exist, the provision of such feedback is not without its disadvantages. For example, in conventional systems, the magnitude or amplitude of an oscillation or vibration imparted to the steering wheel (or other steering system component) is typically the same each time oscillatory feedback is provided. While this may be reasonable when, for example, the vehicle is traversing a relatively smooth road surface and/or is travelling at a relatively low rate of speed, when the vehicle is traversing a relatively rough road surface and/or at a relatively high rate of speed, the imparted vibration may not be noticeable, or at least not sufficiently noticeable, to the driver due to, at least in part, vibration feedback imparted onto the vehicle by the road surface.

Accordingly, it is an aim of the present invention to address, for example, the disadvantages identified above.

### SUMMARY OF THE INVENTION

According to one aspect of the invention for which protection is sought, there is provided a method for controlling the provision of oscillatory feedback through a steering system of a vehicle. In an embodiment, the method comprises: receiving a request to provide oscillatory feedback through the steering system of the vehicle; determining a characteristic of a road surface being traversed by the vehicle; and imp mina to a component of the steering system an oscillating force having one or more oscillation properties that is/are dependent upon the determined road surface characteristic. In an embodiment, the road surface characteristic comprises a surface roughness of the road surface being traversed, and/or the one or more oscillation properties comprise an amplitude of the oscillation force. In an embodiment, the method also comprises determining a speed of the vehicle as the vehicle traverses the road surface, and in such an embodiment, the imparting step comprises imparting to the component of the steering system an oscillating force having one or more oscillation properties that is/are dependent upon the determined road surface characteristic and the determined vehicle speed.

According to another aspect of the invention for which protection is sought, there is provided a method for controlling the provision of oscillatory feedback through a steering system of a vehicle. In an embodiment, the method comprises: receiving a request to provide oscillatory feedback through the steering system of the vehicle; determining a speed of the vehicle as the vehicle traverses a road surface; and imparting to a component of the steering system an oscillating force having one or more oscillation properties that is are dependent upon the determined vehicle speed. In an embodiment, the one or more oscillation properties comprise an amplitude of the oscillating force. In an embodiment, the method also comprises determining a a characteristic of the road surface being traversed, and in such an embodiment, the imparting step comprises imparting to the component of the steering system an oscillating force having one or more oscillation properties that is/are dependent upon the determined vehicle speed and the determined road surface characteristic.

According to a still further aspect of the invention for which protection is sought, there is provided a method for controlling the provision of oscillatory feedback through a steering system of a vehicle. In an embodiment, the method comprises: receiving a request to provide oscillatory feedback through the steering system of the vehicle; and imparting to a component of the steering system an oscillating force, wherein the imparting of the oscillating force comprises one or both of ramping in the oscillating force and ramping out the oscillating force.

As used herein ramping in and ramping out will be understood to mean gradually increasing, over a time period, the oscillating force in amplitude until it reaches the requested amplitude, and gradually reducing, over a time period, the oscillating fore amplitude from the requested amplitude.

According to another aspect of the invention for which protection is sought, there is provided a method for providing oscillatory feedback to a driver of a vehicle via a driver-operated steering wheel within the vehicle. In an embodiment, the method comprises receiving a request to provide oscillatory feedback through the steering wheel of the vehicle during operation of the vehicle over a road surface; determining a road roughness characteristic indicative of a surface roughness of the road surface being traversed by the vehicle; and imparting to the steering wheel an oscillating force that produces a tactile vibration of the steering wheel and that has a magnitude or amplitude that is dependent on the determined road surface characteristic.

According to a yet still further aspect of the invention for which protection is sought, there is provided a system for providing oscillatory feedback through a steering system of a vehicle, comprising: means for receiving a request to provide oscillatory feedback through the steering system of the vehicle; means for determining a characteristic of a road surface being traversed by the vehicle; and means for causing an oscillating force to be imparted to a component of the steering system having one or more oscillation properties that is/are dependent upon the determined road surface characteristic. In an embodiment, the road surface characteristic comprises a surface roughness of the road surface being traversed, and/or the one or more oscillation properties comprise an amplitude of the oscillation force. In an embodiment, the system also comprises means for determining a speed of the vehicle as the vehicle traverses the road surface, and in such an embodiment, the means for causing an oscillation force to be imparted comprises means for causing an oscillating force to be imparted that has one or more oscillation properties that is/are dependent upon the determined road surface characteristic and the determined vehicle speed.

In an embodiment, the receiving, road surface characteristic determining, and causing means, and, if applicable, vehicle speed determining means, comprise an electronic processor having one or more electrical inputs for receiving at least the request to provide oscillatory feedback, and an electronic memory device electrically coupled to the electronic processor. The electronic processor is configured to access the memory device and to execute the instructions stored therein such that it is configured to: receive the request to provide oscillatory feedback; determine the road surface characteristic; and cause the oscillating force to be imparted to the component of the steering system. In embodiment, the electronic processor is further configured to determine the speed of the vehicle, and to cause an oscillating force to be imparted to a component of the steering system having one or mote properties that is/are dependent on the determined road surface characteristic and the determined vehicle speed.

According to another aspect of the invention for which protection is sought, there is provided a system for providing oscillatory feedback through a steering system of a vehicle, comprising: means for receiving a request to provide oscillatory feedback through the steering system of the vehicle; means for determining a speed of the vehicle as the vehicle traverses a road surface; and means for causing an oscillating force to be imparted to a component of the steering system having one or more oscillation properties that is/are dependent upon the determined vehicle speed. In an embodiment, the one or more oscillation properties comprise an amplitude of the oscillation force. In an embodiment, the system also comprises means for determining a road surface characteristic of the road surface being traversed, and in such an embodiment, the means for causing an oscillation force to be imparted comprises means for causing an oscillating force to be imparted that has one or more oscillation properties that is/are dependent upon the determined vehicle speed and the determined road surface characteristic.

In an embodiment, the receiving, vehicle speed determining, and causing means, and, if applicable, road surface characteristic determining means, comprise an electronic processor having one or more electrical inputs for receiving at least the request to provide oscillatory feedback, and an electronic memory device electrically coupled to the electronic processor. The electronic processor is configured to access the memory device and to execute the instructions stored therein such that it is configured to: receive the request to provide oscillatory feedback; determine the vehicle speed; and cause the oscillating force to be imparted to the component of the steering system. In embodiment, the electronic processor is further configured to determine the road surface characteristic, and to cause an oscillating force to be imparted to a component of the steering system having one or more properties that is/are dependent on the determined vehicle speed and the determined road surface characteristic.

According to a further aspect of the invention for which protection is sought, there is provided system tor providing oscillatory feedback through a steering system of a vehicle. In on embodiment, the system comprises: means for receiving a request to provide oscillatory feedback through the steering system of the vehicle; and means for causing an oscillatory force to be imparted to a component of the steering system, and for causing the oscillatory force to be ramped in and/or ramped out.

In an embodiment, the receiving and causing means comprise an electronic processor having one or more electrical inputs for receiving at least the request to provide oscillatory feedback, and an electronic memory device electrically coupled to the electronic processor. The electronic processor is configured to access the memory device and to execute the instructions stored therein such that it is configured to: receive the request to provide oscillatory feedback; and to cause the oscillating force to be imparted to a component of the steering system, and to cause the oscillatory force to be ramped in and/or ramped out.

According to a still further aspect of the invention for which protection is sought, there is provided an electronic controller for a vehicle having a storage medium associated therewith storing instructions therein that when executed by the controller causes the provision of oscillatory feedback through a steering system of the vehicle in accordance with the method of: receiving a request to provide oscillatory feedback through the steering system of the vehicle; determining a characteristic of a road surface being traversed by the vehicle; and imparting to a component of the steering system an oscillating force having one or more oscillation properties that is/are dependent upon the determined road surface characteristic. In an embodiment, the road surface characteristic comprises a surface roughness of the road surface being traversed, and/or the one or more oscillation properties comprise an amplitude of the oscillation force.

According to a yet still further aspect of the invention for which protection is sought, there is provided an electronic controller for a vehicle, having a storage medium associated therewith storing instructions therein that when executed by the controller causes the provision of oscillatory feedback through a steering system of the vehicle in accordance with the method of: receiving a request to provide oscillatory feedback through the steering system of the vehicle; determining a speed of the vehicle as the vehicle traverses a road surface; and imparting to a component of the steering system an oscillating force having one or more oscillation properties that is/are dependent upon the determined vehicle speed. In an embodiment, the one or more oscillation properties comprise an amplitude of the oscillation force.

According to another aspect of the invention for which protection is sought, there is provided an electronic controller for a vehicle having a storage medium associated therewith storing instructions therein that when executed by the controller causes the provision of oscillatory feedback through a steering system of the vehicle in accordance with the method of: receiving a request to provide oscillatory feedback through the steering system of the vehicle; and imparting to a component of the steering system an oscillating force, wherein the imparting of the oscillating force comprises one or both of ramping in the oscillating force and ramping out the oscillating force.

According to yet another aspect of the invention for which protection is sought, there is provided a vehicle comprising at least one of the systems or electronic controllers described herein.

According to a further aspect of the invention for which protection is sought, there is provided a vehicle steering system comprising at feast one of the systems or electronic controllers described herein.

According to a yet further aspect of the invention for which protection is sought, there is provided an electric power assisted steering (EPAS) system for a vehicle comprising at least one of the systems or electronic controllers described herein.

According to a still further aspect of the invention for which protection is sought, there is provided a non-transitory, computer-readable storage medium storing instructions thereon that when executed by one or more electronic processors causes the one or more processors to carry out at least one of the methods described herein.

Optional features of the various aspects of the invention are set out below in the dependent claims.

At least some embodiments of the present invention have the advantage that because the magnitude or strength of oscillatory feedback may be varied based on conditions such as road surface roughness and/or vehicle speed, when a vehicle is traversing a road surface that is relatively rough and/or at a relative high rate of speed and oscillatory feedback is needed or desired, the oscillatory feedback that is provided is stronger (e.g., greater in magnitude or amplitude) than it would be if the prevailing road surface was relatively smooth or the vehicle speed was relative low. As a result, effects that the roughness of the road surface and/or vehicle speed has on the vehicle are accounted for in the provision of the feedback and thus the resulting feedback is more noticeable to the driver.

Within the scope of this application it is expressly intended that the various aspects, embodiments, examples, and alternatives set out in the preceding paragraphs, in the claims, and/or in the following description or drawings, and in particular the individual features thereof, may be taken independently or in any combination. That is, all embodiments and/or features of any embodiment can be combined in, any way and/or combination, unless such features are incompatible. The applicant reserves the right to change any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, wherein like designations denote like elements, and in which:

FIG. 1 is a schematic side view of a vehicle comprising an illustrative embodiment of a vehicle steering system;

FIG. 2 is a schematic view of the vehicle steering system illustrated in FIG. 1;

FIG. 3 is a schematic view of an illustrative embodiment of a motor and rack and pinion coupling of the steering system illustrated in FIG. 2;

FIG. 4 depicts an example of oscillatory feedback comprising a sequence of three (3) oscillating pulses;

FIGS. 5a-5c each depict a example of scaling factor vs. vehicle speed curves illustrating how oscillatory feedback may be scaled in dependence on vehicle speed;

FIG. 6 depicts an example of oscillatory feedback comprising a sequence of three (3) oscillating pulses wherein the oscillatory feedback is ramped in and out for each pulse; and

FIGS. 7 and 8 are flow diagrams depicting various steps of illustrative embodiments of a method for providing oscillatory feedback through a steering system of a vehicle.

### DETAILED DESCRIPTION

The systems and methods described herein may be used to provide oscillatory feedback through a steering system of a vehicle. In an embodiment, the systems and methods receive a request to provide oscillatory feedback through the steering system of the vehicle, determine a characteristic of a road surface being traversed by the vehicle, and impart (or cause to be imparted) to a component of the steering system an oscillating force having one or more oscillation properties that is/are dependent upon the determined road surface characteristic.

References herein to a block such as a function block are to be understood to include reference to software code for performing the function or action specified in which an output is provided responsive to one or more inputs. The code may be in the form of a software routine or function called by a main computer program, or may be code forming part of a flow of code not being a separate routine or function. Reference to function blocks is made for ease of explanation of the manner of operation of a control system according to an embodiment of the present invention.

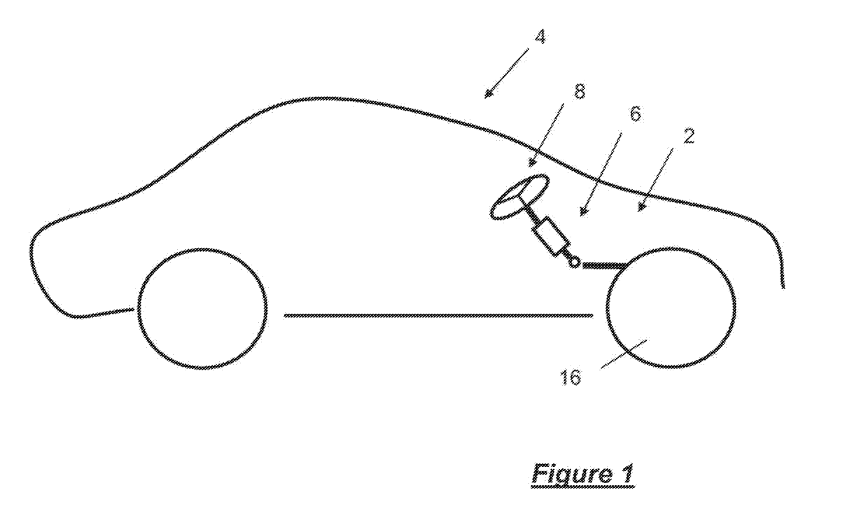

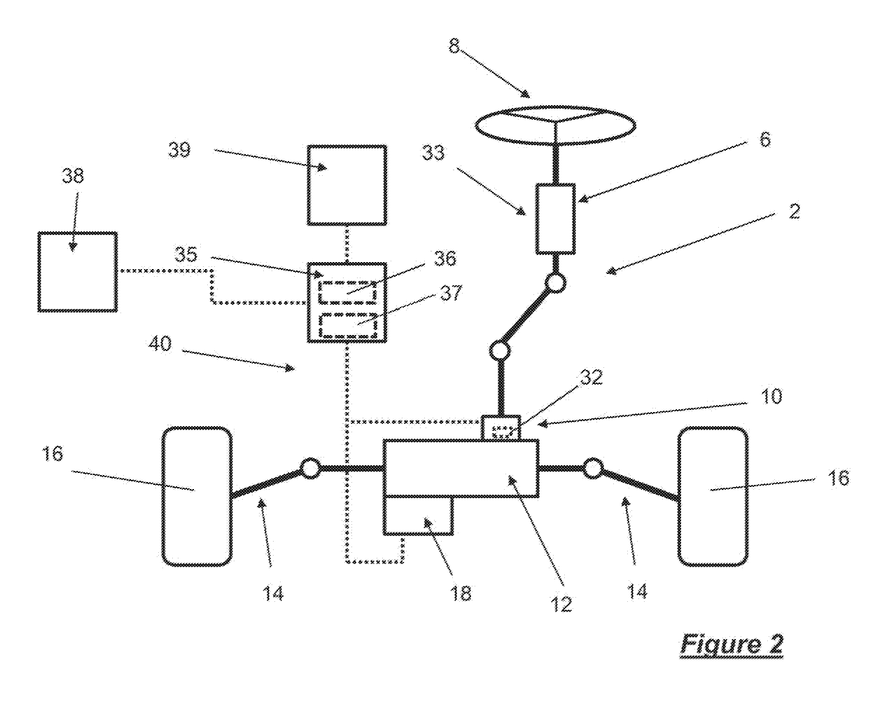

With reference to FIGS. 1 and 2, there is shown a steering system 2 of a vehicle 4. Although the following description is provided in the context of the particular vehicle illustrated in FIGS. 1 and 2, it will be appreciated that this vehicle merely an example and that other vehicles may certainly be used instead. For instance, in various embodiments, the methods and systems described herein may be used with any type of vehicle having an automatic, manual, or continuously variable transmission, including traditional vehicles, hybrid electric vehicles (HEVs), extended-range electrical vehicles (EREVs), battery electric vehicles (BEVs), passenger cars, sports utility vehicles (SUVs), cross-over vehicles, and trucks, to cite a few possibilities. In any event, according to an illustrative embodiment, the steering system 2 comprises a rotatable steering column 6 coupled at a proximal end to a driver steering input device in the form of a steering wheel 8. At an opposed, distal end, the steering column 6 comprises a pinion 10.

In FIG. 1, the distal end of steering column 6 and distal components of steering system 2 linked thereto are not shown in the interest of clarity. Referring now therefore specifically to the illustrative embodiment illustrated in FIG. 2, a steering member in the form of a rack bar 12 is co-operable and mechanically coupled with steering column 6, and pinion 10 thereof, in particular, such that rotary motion of steering column 6 causes linear motion of rack bar 12, and linear motion of rack bar 12 causes rotary motion of steering column 6. Furthermore, in the illustrated embodiment, rack bar 12 is coupled via first and second tie rod assemblies 14 to first and second wheels 16, such that linear motion of rack bar 12 causes first and second wheels 16 to be steered. Wheels 16 may thus be steered by rotation of steering wheel 8, which leads to rotation of steering column 6, which in turn causes linear movement of rack bar 12 and steering of wheels 16.

In an embodiment, steering of wheels 16 is assisted by an actuator in the form of an electric steering assistance motor 18 coupled to, for example, rack bar 12. In such an embodiment, steering system 2 is thus an Electric Power Assisted Steering (EPAS or EPS) system, or vehicle 4 at least includes an EPAS system that is used in conjunction with steering system 2.

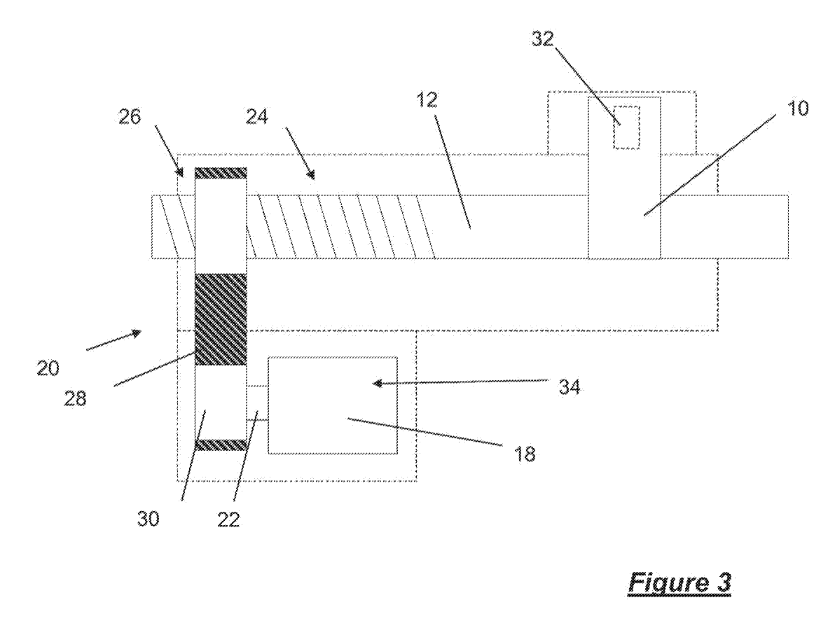

Referring now to FIG. 3, in an illustrative embodiment, steering assistance motor 18 is coupled to rack bar 12 in a parallel-axis arrangement. In particular, rack bar 12 is linearly movable along a first axis, and electric motor 18 comprises a rotor rotatable about a second axis, the first and second axes being generally parallel. For purposes of this disclosure, “generally parallel” is intended to include instances where the first and second axes are exactly parallel, and those instances wherein the axes are not exactly parallel but are nonetheless suitably arranged such that rack bar 12 and motor 18 operate as intended (e.g., within an acceptable tolerance of the components). It will be appreciated, that while a parallel-axis arrangement of rack bar 12 and motor 18 has been described, the present invention is not intended to be limited to any particular arrangement(s) of motor 18 and rack bar 12, as any suitable arrangement may be used, including those in which the axes of the motor 18 and rack bar 12 may not be parallel.

Referring particularly to the embodiment depicted in FIG. 3, steering assistance motor 18 is coupled to rack bar 12 via a coupling 20 that translates rotary movement of a rotor 22 of motor 18 into linear force upon rack bar 12. In the illustrated embodiment, rack bar 12 comprises a screw thread 24 and a fixedly-positioned ball assembly 26. Ball assembly 26 is configured to be driven by motor 18 and is engaged with screw thread 24 of rack bar 12 such that it acts as a nut. Motor 18 is therefore able to impart linear force and movement to rack bar 12 by rotating ball assembly 26. In an embodiment, ball assembly 26 is driven by motor 18 via a toothed belt 28, and rotor 22 of motor 18 comprises a pinion 30 for engaging toothed belt 28. The amount of torque applied to rack bar 12 by motor 18 may be determined in a number of ways. Because motor torque is proportional to the amount of current being applied to the motor, one way of determining the amount of torque being applied to rack bar 12 by motor 18 is by monitoring or measuring the amount of current being applied to motor 18. It will be appreciated, however, that other suitable techniques may certainly be used instead.

Referring again to FIG. 2, one or more torque seniors 32 in the region of pinion 10 may be provided and used to monitor, sense, detect, measure, or otherwise determine any steering torque that is indicative of a steering input provided by the driver through steering wheel 8. Torque sensor(s) 32 may comprise any suitable torque sensor known in the art that is capable of determining an amount of steering torque that is being applied in dependence on a driver steering input. One example, though certainly not the only one, of a suitable torque sensor is a torsion bar torque sensor. Steering system 2 may further include one or more steering angle sensor(s) 33 for monitoring, sensing, detecting, measuring, or otherwise determining one or more steering angle-related parameters indicative of a steering input provided by the driver of vehicle 10. Examples of steering angle-related parameters may include one or more of: a steering angle imparted to a component of steering system 2, for example, steering column 6; a change in an imparted steering angle; and/or a rate of change of an imparted steering angle, to cite a few possibilities. In an embodiment, steering angle to sensor 33 is configured to provide an initial steering angle value that may be used as a benchmark or reference value for monitoring one or more steering angles-related parameters during operation of vehicle 10. Steering angle sensor 33 may comprise any suitable sensor known in the art that is capable of measuring a steering angle in dependence on a driver steering input.

Furthermore, and as shown in FIG. 3, motion of rack bar 12 is detected by a rotor position sensor 34 (e.g., a rotary position sensor) within or associated with motor 18. In an embodiment, information provided by position sensor 34 may also be used in conjunction with information provided by steering angle sensor 33 (e.g., an initial steering wheel angle value) to monitor or otherwise determine one or more steering angle-related parameters, such as, for example, those described elsewhere herein, during operation of vehicle 10.

In any event, a steering control means 35 in the form an electronic controller (i.e., controller 35) may be provided that receives information from various sources, for example, one or more of sensors 32-34, and uses that information to, among potentially other things, calculate an amount of assistive torque to apply. Controller 35 may also command or control motor 18 via, for example, a controller area network (CAN) bus, a system management bus (SMBus), a proprietary communication link, or using another suitable communication technique, to apply that assistive torque.

It is to be understood that electronic controller 35 described herein can comprise a control unit or computational device having one or more electronic processors (e.g., a microprocessor, a microcontroller, an application specific integrated circuit (ASIC), etc.), and that system 2 may comprise a single control unit or computational device or alternatively different functions of controller 35 may be embodied in, or hosted in, different control units or computational devices. As used herein, the terms “control unit,” “controller,” and “computational device” will be understood to include a single control unit, controller, or computational device, as well as a plurality of control units, controllers, or computational devices collectively operating to provide the required control functionality. A set of instructions could be provided which, when executed, cause controller 35 to implement the control techniques described herein (including some or all of the functionality of the methodology described herein). The set of instructions could be embedded in said one or more electronic processors of controller 35; or alternatively, could be provided as software to be executed in said controller 35. A first controller may be implemented in software run on one or more processors. One or more other controllers may be implemented in software run on one or more processors, optionally the same one or more processors as the first controller. Other arrangements are also useful.

In an illustrative embodiment such as that shown in FIG. 2, controller 35 comprises an electronic processor 36 having one or more electrical inputs and one or more electrical outputs. Electronic processor 36 may comprise any suitable electronic processor (e.g., a microprocessor, a microcontroller, an ASIC, etc.) that is configured to execute electronic instructions. Controller 35 further includes an electronic memory device 37 that is either part of, or electrically connected to and accessible by, processor 36. Electronic memory device 37 may comprise any suitable memory device and may store a variety or data, information, and/or instructions therein or thereon. In an embodiment, memory device 37 has information and instructions for software, firmware, programs, algorithms, scripts, applications, information etc. stored therein or thereon that may govern all or part of the methodology described herein. Processor 36 may access memory device 37 and execute and/or use the information and/or instructions stored therein or thereon to carry out or perform some or all of the functionality and methodology describe herein. Alternatively, some or all of the aforementioned instructions/information may be embedded in a computer-readable storage medium (e.g. a non-transitory non-transient storage medium) that may comprise any mechanism for storing information in form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; electrical or other types of medium for storing such information/instructions.

In addition to the above, controller 35 may also be electronically connected to and configured to communicate with other components of system 2 or vehicle 4 (e.g., sensor(s), vehicle systems, motor 18, etc. described above and below) via suitable communications (e.g. CAN bus, SMBus, a proprietary communication link, or through some other arrangement known in the art) and can interact with them when or as required.

It will be appreciated that in addition to or in lieu of one more of sensors 32-34 described above, steering system 2 or vehicle 4 (e.g., a system of vehicle 4 other than steering system 2) may include any number of different sensors, components, devices, modules, systems, etc., configured to monitor, sense, detect, measure, or otherwise determine a variety of vehicle-related parameters. These may include, example, one or more of: steering column torque sensor(s) for monitoring, sensing, detecting, measuring, or otherwise determining steering torque imparted to steering column 6; vehicle speed sensor(s) for monitoring, sensing, detecting, measuring, or otherwise determining the speed of the vehicle 4; suspension articulation sensor(s) for monitoring, sensing, detecting, measuring, or otherwise determining suspension articulation or displacement; and/or proximity sensor(s) for monitoring, sensing, detecting, measuring, or otherwise determining proximity of the vehicle 4 to another one or more of a moving or stationary object, and which may include, for example, forward or rearward looking radar or LIDAR sensors, ultrasonic sensors or the like.

The sensors of system 2 or vehicle 4 may provide information that can be used by the methodology described herein, and may be embodied in hardware, software, firmware, or some combination thereof. The sensors may directly sense or measure the conditions or parameters for which they are provided, or they may indirectly evaluate such conditions/parameters based on information provided by other sensors, components, devices, modules, systems, etc. (e.g., the value of a particular parameter may be derived from information provided by one or more sensors as opposed to comprising the information itself). Further these sensors may be directly coupled to controller 35, indirectly coupled thereto via other electronic devices, vehicle communications bus, network, etc., or coupled in accordance with some other suitable arrangement known in the art.

In addition to being configured to provide assistive torque as described above, in at least some embodiments, motor 18 may also be configured for receiving and executing other commands from controller 35 for providing oscillatory feedback, for example, haptic (e.g., tactile vibration) and/or audible feedback via steering system 2 that is perceptible by the driver of the vehicle (e.g., via steering wheel 8). In other words, motor 18 may be controlled or commanded by controller 35 to generate oscillatory feedback that is provided or communicated to the driver of vehicle 4 via one or more components of steering system 2. In an illustrative embodiment, controller 35 is configured to receive a request to provide oscillatory feedback through steering system 2 and in dependence thereon, to send an oscillation command to motor 18 to impart an oscillating force to rack bar 12 or another component of steering system 2 operatively coupled (i.e., directly or indirectly via one or more other component) to motor 18. Accordingly in an embodiment, the motor 18 and controller 35 are thus each configured for shared functionality (e.g., assistive steering torque and oscillatory feedback); and in an embodiment, motor 18 may be commanded by controller 35 to simultaneously apply assistive torque and impart an oscillating force to rack bar 12.

In any event, the request to provide oscillatory feedback may take a number of forms. In an illustrative embodiment, the request comprises an electrical signal representative of an actual command to provide oscillatory feedback received from a component or system of vehicle 4 that is configured to determine whether one or more defined conditions exist. In other words, when the component or system configured to determine whether one or more defined conditions exist determines that the defined condition(s) does in fact exist, it sends electrical signal commanding the provision of oscillatory feedback to controller 35 via, for example, a CAN bus or using another suitable communication technique. In another illustrative embodiment, the request comprises an electrical signal indicative of the existence of one or more defined conditions received from a component or system of vehicle 4 configured to determine whether the one or more defined conditions exist. In other words, when the component or system configured to determine whether one or more defined conditions exist determines that the defined condition(s) does in fact exist, it sends an indicator or warning signal to controller 35 via, for example, a CAN bus or using another suitable communication technique, that informs controller 35 that the condition exists. In yet another illustrative embodiment, controller 35 may be configured to determine whether one or more defined conditions exist. In such an embodiment, the request may comprise an electrical signal received from a sensor or other component of vehicle 4 either directly or indirectly via, for example, a CAN bus of using another suitable communication technique, that is representative of a value of a particular parameter that is indicative of the existence of one or more defined conditions. Controller 35 is configured to interpret the received value and to determine that the defined condition(s) exist. Accordingly, it will be appreciated that the request to provide oscillatory feedback is not limited to any particular form or type of request.

As described above, in an embodiment, a request to provide oscillatory feedback is based on the existence of one or more defined conditions. The defined conditions may comprise any number of conditions. One such condition relates to the position of the vehicle in the lane in which it is travelling, and comprises detecting that the vehicle is departing (e.g., drifting) from the lane (i.e., a lane departure warning state). Another condition relates to driver alertness, and comprises detecting that the driver is drowsy (i.e., driver alertness warning state). Other examples of conditions may include, without limitation, the vehicle speed exceeding a particular threshold (i.e., a vehicle speed warning state), and a forward alert warning being triggered alerting the driver that the distance or time separation to a vehicle ahead has fallen below a particular threshold value (i.e., a forward alert warning state). While several examples of possible conditions have been specifically identified, it will be appreciated that conditions in addition to or in lieu of those identified above may certainly be used for the purposes described herein, as the present invention is not intended to be limited to any particular condition(s).

A determination as to whether one or more defined conditions exist may be made by any number of components or systems of vehicle 4. For example, one or more systems or components 38 of vehicle 4 other than steering system 2 may be configured to determine whether one or more defined conditions exist. These components or systems may be dedicated components or systems or may be shared systems or components configured to perform other functionality (e.g., an electronic vehicle control unit 39). In either instance, systems/component 38, 39 are further configured to provide a notification in one form or another to controller 35 when it is determined that the respective condition(s) exist. Additionally or alternatively, and as briefly described above, controller 35 may be configured to determine whether one or more defined conditions exist. In any instance, a determination as to whether one or more defined conditions exist may be based on information received from one or more systems or components (e.g., sensors) of vehicle 4, including, for example, components of steering system 2, one or more of the vehicle sensors identified herein, and/or other vehicle components/systems, for example, electronic vehicle control unit 39. By way of illustration, an example of a lane departure sensor arrangement that may be used to determine if a lane departure-related condition exists is described in WO2098991565 A1, the entire contents of which are incorporated herein by reference.

In an embodiment, the controller 35 is configured to periodically (e.g., once per second, half second, etc.) determine whether a command for oscillatory feedback is needed or is appropriate. Controller 35 may be configured with a routine for determining regularly, e.g. once per second, half second, etc., whether an oscillation command should be sent to motor 18. If appropriate, controller 35 may be further configured to distinguish between distinct variants of a particular defined condition (e.g., different lane departure warning states).

In any event, the oscillation may be imparted by alternation of the direction of, and/or changing, in particular, a pulsed change to, the speed of motor 18. In an embodiment, there is minimal or no net movement of rack bar 12 as a result of the oscillation command applied to rack bar 12. In other words, rack bar 12 may return to its original position after the oscillation, subject to any other movement of rack bar 12, e.g., due to driver steering input and/or steering assistance.

The oscillation command sent by controller 35 may include instructions relating to one or more properties of the oscillation to be imparted by motor 18, including, for example, one or more of timing, frequency and amplitude (or magnitude) of the oscillation. The properties of the oscillation are consistent with providing desired oscillatory (e.g., haptic and audible) feedback, in particular structure borne noise or vibration. In an embodiment, an oscillation having a duration in the range of from 0.5 to 3 seconds, for example, in the range of from 1 to 2 seconds, and, in an embodiment, about 1.6 seconds. In an embodiment, the oscillation has a frequency in the range of from 15 to 35 Hz, for example, in the range of from 25 to 27 Hz, and, in an embodiment, about 26 Hz. In an embodiment, the oscillation provides a handed torque in the range of from 0.5 to 5 Nm, for example in the range of from 1 to 3 Nm in steering column 6, and, in an embodiment, about 2 Nm. In an embodiment, the maximum displacement of the steering member (e.g., rack bar 12) by the oscillation is in the range of from 0 to 0.5 mm, for example in the range of from 0 to 0.1 mm, and, in an embodiment, about 0.1 mm, and in another embodiment, about 0.09 mm. It will be appreciated, however, that the present invention is not limited to the property values identified above.

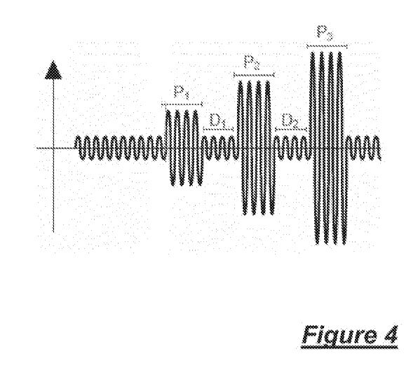

The oscillatory feedback, and thus the imparted oscillation or oscillating force associated therewith, may comprise a single pulse or a sequence of pulses. By way of example, FIG. 4 illustrates an embodiment wherein the provided oscillatory feedback comprises three (3) oscillating pulses P₁, P₂, and P₃ with a time period D₁ between the first and second pulses P₁ and P₂, and a time period D₂ between the second and third pulses P₂ and P₃. In the embodiment depicted in FIG. 4, the pulses have different (increasing) amplitudes but the same duration and frequency. It will be appreciated, however, that in other embodiments, two or more of the pulses may have the same amplitude, and/or one or more pulses may have a different duration and/or frequency than one or more of the other pulses. It will be appreciated that while in the above-described embodiment the oscillatory feedback comprises three (3) pulses, in other embodiments, The feedback may comprise more or less than three (3) pulses as the present invention is not limited to feedback having any particular number of pulses.

In any event, in an embodiment, controller 35 is configured for selecting an oscillation command from a plurality of oscillation commands, and to send that selected command to, for example, motor 18. In this way steering system 2 is configured to offer a range of oscillatory feedback. In an embodiment, a list of oscillation commands is stored and mapped against, for example, associated warnings (e.g., lane departure warnings or types of warnings other than lane departure warnings, as the case may be) and/or conditions relating to the operation of vehicle 4 (e.g., road surface characteristics (e.g., surface or road roughness), vehicle speed, etc.) in one or more empirically-derived data structures (e.g., multi-dimensional look-up table(s), curve(s), or profile(s)) accessible by or within controller 35 (e.g., stored in a memory device of or accessible by controller 35 (e.g., memory device 37). In an embodiment, each warning or condition in the data structure is mapped to or correlated with a single oscillation command. In other embodiments, however, such as, for example, wherein the feedback being provided may comprise a sequence of pulses, each warning or condition may be mapped to or correlated with a plurality of oscillation commands each corresponding to a particular pulse.

To better illustrate, and as will be described in greater detail below, in an embodiment wherein controller 35 is configured to select an oscillation command based at least in part on the roughness of the road surface being traversed by vehicle 4, an empirically-derived look-up table that correlates road surface roughness (input) with oscillation commands (output) may be provided and used by controller 35 to select an appropriate oscillation command. Similarly, in an embodiment wherein controller 35 is configured to select an oscillation command based at least in part on the prevailing speed of vehicle 4, an empirically-derived look-up table that correlates vehicle speed (input) with oscillation commands (output) may be provided and used by controller 35 to select an appropriate oscillation command. And in an embodiment wherein controller 35 is configured to select an oscillation command based on both the roughness of the road surface being traversed by vehicle 4 and the prevailing speed of vehicle 4, an empirically-derived look-up table that correlates road surface roughness and vehicle speed (inputs) with oscillation commands (output) may be provided and used by controller 35 to select an appropriate oscillation command.

In any event, in an embodiment, each one of the plurality of oscillation commands comprises instructions related to the properties of its associated oscillation. To enable distinct oscillatory feedback in dependence on distinct conditions, e.g., lane departure warnings, road surface roughness, vehicle speed, etc., the plurality of oscillation commands comprises a plurality of oscillation commands with differing instructions related to one or more properties of their oscillations. For example, in an embodiment, one of the plurality of oscillation commands may comprise an instruction relating to the amplitude of an associated oscillation (e.g., an oscillation of the oscillating force to be imparted) that is different than that of one or more other of the plurality of oscillatory commands. In other words, one oscillation command may comprise an instruction for oscillation amplitude that is higher than that of one or more other oscillation commands. Accordingly, in an embodiment, properties of the oscillation or oscillatory force imparted to provide oscillatory feedback may vary in dependence on one or more existing or prevailing conditions including, but not limited to, those identified above.

In another embodiment, rather than controller 35 being configured to select an oscillation command from a plurality oscillation commands in order to allow steering system 2 to offer a range of oscillatory feedback, controller 35 may be configured to select a scaling factor or multiplier to be applied to one or more particular properties of a base or default oscillation command (e.g., frequency, amplitude, or duration) to thereby create an adjusted oscillation command. In an illustrative embodiment, each scaling factor may have a value between 0.00 and 1.00, though the present invention is not intended to be limited to such a range. In such an embodiment, a list of scaling factors/multipliers is stored and mapped against, for example, associated warnings (e.g., lane departure warnings or types of warnings other than lane departure warnings, as the case may be) and/or conditions relating to the operation of vehicle 4 (e.g., road surface characteristics (e.g., surface or road roughness), vehicle speed, etc.) In one or more empirically-derived data structures (e.g., multi-dimensional look-up table(s), curve(s), or profile(s)) accessible by or within controller 35 (e.g., stored in a memory device of or accessible by controller 35 (e.g., memory device 37).

In an embodiment, each warning Of condition in the data structure is mapped to or correlated with a single scaling factor to be applied to a single oscillation property (e.g., amplitude). In other embodiments, however, each warning or condition may be mapped to or correlated with a plurality of scaling factors. In such an embodiment, each scaling factor may correspond to a respective oscillation property (e.g., frequency, duration, amplitude). Alternatively, in an embodiment wherein the oscillatory feedback being provided comprises a sequence of pulses, each scaling factor may correspond to a particular pulse.

To better illustrate, ire an embodiment, controller 35 is configured to select a scaling factor based at least in part on the roughness of the road surface being traversed by vehicle 4. Accordingly, an empirically-derived look-up table that correlates road surface roughness (input) with scaling factors (output) may be provided and used by controller 35 to select an appropriate scaling factor to apply to a base oscillation command. More particularly, controller 35 may look up a determined road roughness in the look-up table and to select the scaling factor corresponding to that particular surface roughness.

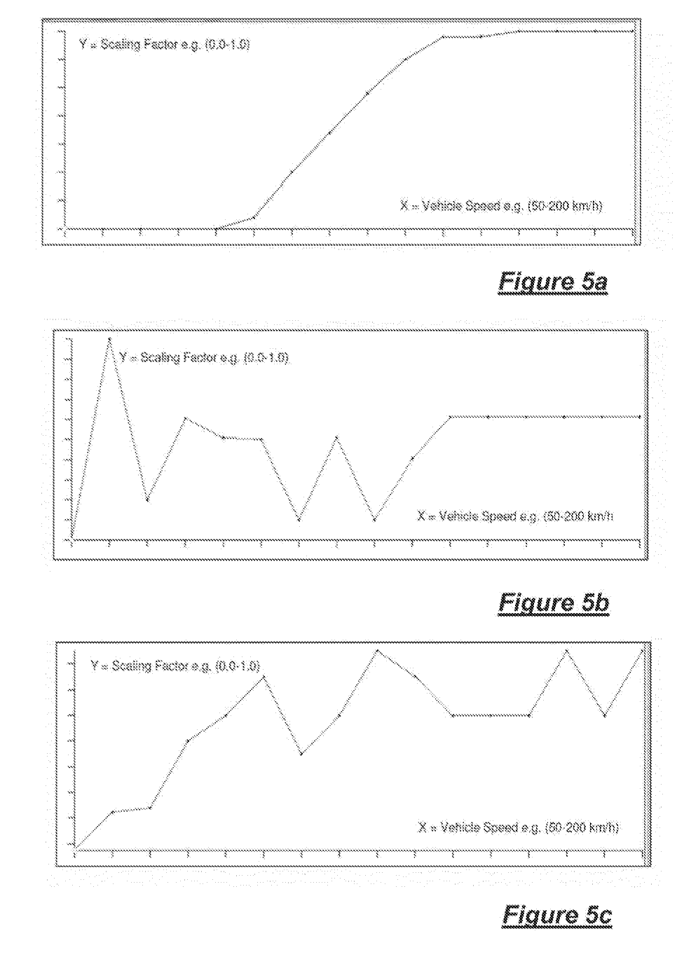

Similarly, in an embodiment wherein controller 35 is configured to select a scaling factor based at least impart on the prevailing speed of vehicle 4, an empirically-derived look-up table that correlates vehicle speed (input) with scaling factors (output) may be provided and used by controller 35 to select an appropriate scaling factor. In an embodiment, the look-up table that is provided is effectively an implementation of an empirically derived scaling factor/speed curve or profile, such as, for example, one of those illustrated in FIGS. 5a-5c. More particularly, a look-up table is provided having “entries” for a plurality of speed values within particular speed range, for example, 0-250 kph, and in an illustrative embodiment, 50-200 kph; though any suitable speed range may be utilized. For example, in an embodiment, the look-up table may include entries that increase incrementally by a particular amount (e.g., 10 kph). Accordingly, in an embodiment wherein the speed range is 50-200 kph, the look-table may include sixteen (16) entries one each of 50, 60, 70, 80, 90, 100, 110, 120, 130, 140, 150, 100, 170, 180, 190, and 200 kph. In any event, controller 35 may look up a determined vehicle speed in the look-up table and select the scaling factor corresponding to that particular speed. In an instance wherein the vehicle speed does not match one of the speeds in the look-up table, controller 35 may be configured to select the scaling factor corresponding to the closest speed in the table, or to determine a scaling factor by interpolating from the scaling factors from the closest speed immediately above and the closest speed immediately below the determined speed.

In an embodiment wherein controller 35 is configured to select a scaling factor based on both the roughness of the road surface being traversed by vehicle 4 and the prevailing speed of vehicle 4, an empirically-derived look-up table that correlates road surface roughness and vehicle speed (inputs) with scaling factors (output) may be provided and used by controller 35 to select an appropriate scaling factor. More particularly, controller 35 may look up a determined road roughness and vehicle speed in the look-up table and select the scaling factor corresponding to that particular surface roughness and vehicle speed.

Once selected, the scaling factor(s) are applied to the base or default oscillation command to create an adjusted oscillation command that is then sent to motor 18. As a result of the application of the scaling factor(s), the adjusted oscillation command may comprise instructions related to properties of the associated oscillation that is/are different than that or those of the base oscillation command. For example, in an embodiment, the adjusted oscillation command may include an instruction relating to the amplitude of an associated oscillation (e.g., an oscillation of the oscillating force to be imparted) that is different than that of the base oscillation command. Accordingly, applying scaling factor(s) to the base or default oscillation command allows for the provision of oscillatory feedback that varies in dependence on one or more existing or prevailing conditions including, but not limited to, those identified above.

In any event, in an instance wherein rotatable steering column 6 is co-operable with rack bar 12, oscillation of rack bar 12 leads to oscillation of steering column 6, particularly rotary oscillation. In this manner steering system 2 provides for effective oscillatory (e.g., haptic) feedback. In particular, since oscillating force is applied relatively distally, i.e., to rack bar 12 rather than directly to steering column 6 or steering wheel 8, an advantageously realistic oscillatory feedback is achieved, closely simulating feedback received via wheels 16 of the vehicle when driving over, for example, a rumble strip.

In an embodiment, steering system 2 also provides for wider oscillatory feedback through the vehicle structure. In particular, rack bar 12 may be mounted such that the oscillating force can be perceived not only through steering column 6 and steering wheel 8, but also through other vehicle surfaces or structures 40. In an embodiment, rack bar 12 is coupled to steerable wheels 16 of vehicle 4 such that the oscillating force is transferred to vehicle structure 40 via the steering and/or suspension of the vehicle not shown). This provides the advantage that oscillatory (e.g., haptic) feedback may still be noticeable even if a driver is not touching steering wheel 8.

In addition to the functionality described above, in at least some implementations controller 35 may be configured to control the provision of the oscillatory feedback such that the application of the oscillatory force that is imparted to provide the oscillatory feedback is ramped in and/or ramped out. An advantage of such a ramping function is that it allows for a gradual rather than abrupt introduction of the oscillatory feedback so as to limit change in the feel of the steering to the driver when feedback is being provided, thereby providing a more smooth and refined feel at steering wheel 8. Accordingly, in an embodiment, the commands sent to motor 18 by controller 35 relating to the provision of oscillatory feedback are such that the feedback is ramped in and/or out.

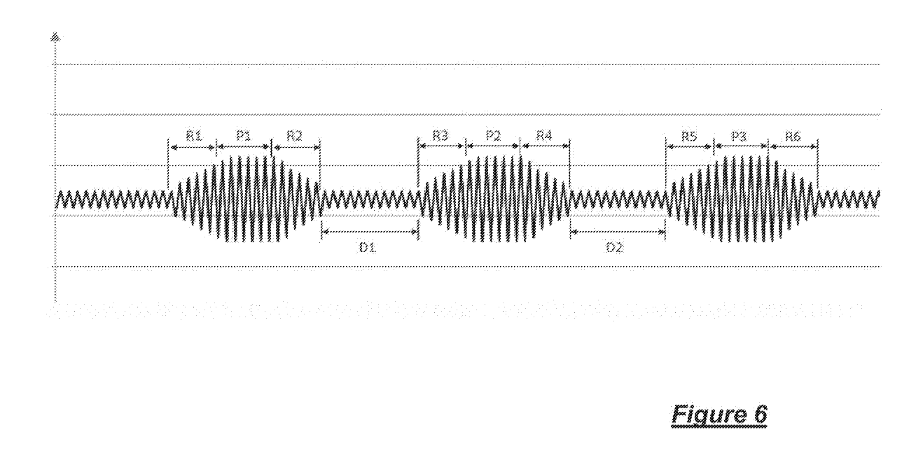

FIG. 6 illustrates an example wherein the ramping function is performed. In this illustrative embodiment, the provided oscillatory feedback once again comprises three (3) oscillating pulses P₁, P₂, and P₃ with a time D₁ between the first and second pulses P₁ and P₂, and a time D₂ between the second and third pulses P₂ and P₃. As shown, upon receipt of a request to provide oscillatory feedback, the first pulse P₁ is ramped in over a time period R₁, and is ramped out over a time period R₂. Time periods R₁ and R₂ may be equal or different in duration; and, in an embodiment, may have values in the range of 0.0-2.0 s, and in a particular embodiment, a value of 0.2 s. Following first pulse P₁—and the elapsing of time periods D₁ and D₂, respectively—each of second and third pulses P₂ and P₃ are sequentially ramped in over respective time periods R₃ and R₅, and ramped out ever respective time periods R₄ and R₆. As with time periods R₁ and R₂, time periods R3-R6 may be equal or different in duration; and, in an embodiment, may have values in the range of 0.0-2.0 s, and in a particular embodiment, a value of 0.2 s. It will be appreciated that while the amplitudes of the pulses in the example shown in FIG. 6 are equal, in other embodiments, the amplitude(s) of one or more of the pulses may be different than one or more of the other pulses. Additionally, while in the illustrated embodiment the oscillatory feedback comprises three (3) pulses, in other embodiments, the oscillatory feedback may comprise more or less than three (3) pulses.

As briefly described above, in at least some embodiments, controller 35 may be configured for determining a combined actuation command based on the oscillation command and a desired steering assist torque. The controller may advantageously be configured for sending the combined actuation command (comprising the oscillation command and a steering assist torque command) to motor 18 for simultaneously applying assistive torque and imparting an oscillating force to rack bar 12, for example by motor 18 alone. In an embodiment, the oscillation command may be superimposed onto the steering assist torque command, thereby allowing controller 35 to continue to assist steering vehicle 4 at the same time as providing oscillatory feedback to the driver.

In view of the foregoing, it will be appreciated that steering system 2 thus illustrates and is configured to perform or carry out a method of providing oscillatory feedback through a steering system by imparting an oscillating force to a linearly movable steering member of the steering system to which a driver steering input is coupled via a rotatable steering column of the steering system. And in an embodiment, the oscillating force that generates the feedback may be provided using an actuator that simultaneously also provides steering assistance to steering system 2.

It will be appreciated that many modifications can be made to steering system 2 without departing from the scope of the invention as defined in, for example, the appended claims. For example, controller 35 could be configured to command oscillatory feedback in additional or alternative defined conditions. A dedicated actuator could be employed for imparting oscillation to the steering member (e.g., rack bar 12) instead of steering assist motor 18, and/or a hydraulic actuator may be used instead of an electric actuator.

In addition to controlling the provision of oscillatory feedback as described above, controller 35 may also be configured to omit sending the oscillation command, and therefore, to inhibit the provision of oscillatory feedback. In an embodiment, this functionality may be in dependence on an override factor, for example, a sharp turn state. A sharp turn state may be determined when the value of a particular parameter is above a predetermined threshold value. For example, a sharp turn state may be determined when the value of an applied steering torque, which may be received from, for example, a vehicle component/system (e.g., electronic vehicle control unit 39 or one or more vehicle sensors, or from a sensor of steering system 2 (e.g., steering torque sensor 32)) is above a particular steering torque threshold. A sharp turn state may be additionally or alternatively determined when the value of a steering angle-related parameter is above a predetermined threshold value. Examples of steering angle-related parameters that may be used include, for example and without limitation, one or more of a magnitude of a steering angle imparted onto a component of steering system 2 (e.g., steering column 6), a change in an imparted steering angle, or a rate of change in an imparted steering angle, to cite a few possibilities.

Apart from performing the assistive torque and oscillatory feedback functions described above, in an embodiment, controller 35 may be further configured to determine one or more characteristics of a road surface being traversed by vehicle 4. More particularly, in an embodiment, controller 35 is configured to determine a road roughness characteristic indicative of a surface roughness of the road surface being traversed by vehicle 4 (also referred to simply as “surface roughness”) when, for example, a request to provide oscillatory feedback is received. Surface roughness of a road surface may be determined by controller 35 in a number of suitable ways. One way is by receiving one or more electrical signals representative of a surface roughness determination made by a different component of steering system 2 or vehicle 4. For example, in an embodiment, a system or component of vehicle 4 other than steering system 2 (e.g., a stability control system, vehicle control unit 39, etc.) may be configured to receive one or more electrical signals each representative of a value of a vehicle-related parameter, and to use that or those values to determine a surface roughness of the road being traversed using techniques known in the art. Another way, however, is by making the determination itself based on information received from one or more other components of vehicle 4 (i.e., deriving the surface roughness from the received information). In either instance, road surface roughness may be determined in any number of ways, including, for example, one or more of those ways/techniques described below, or using any other suitable way/technique known in the art.

In an embodiment, road surface roughness may be determined by receiving signal(s) from one or more suspension articulation or displacement sensors and processing the value(s) represented thereby to determine or calculate a road surface roughness (e.g., by comparing the values to one or more thresholds each corresponding to a respective road surface roughness or degree of roughness).

In another embodiment, road surface roughness may be determined from the amount of steering torque being applied via, for example, a steering input provided by the driver through steering wheel 8. More particularly, the steering wheel torque may be periodically sampled (e.g., every 20 ms, for example) using, for example, steering torque sensor 32, and if there is a variation in successive samples or over a certain number of samples of more than a predetermined amount (e.g., 2 Nm), then it can be determined that that road surface is rough. In other words, the steering torque is monitored for noise or chatter and if a sufficient amount of such chatter is detected, a determination can be made that the road surface is a rough road surface.

In still another embodiment, road surface roughness may be determined from the amount of linear force applied to rack 12 and more particularly, the amount of noise or chatter in the applied force. More particularly, the steering torque being applied to rack 12 via, for example, a steering input provided by the driver, and the torque being applied to rack 12 by motor 18 may be may be periodically sampled using, for example, steering torque sensor 32 (for driver-applied steering torque) and a measured applied motor current (for motor torque). These torque amounts may be processed along with other known information relating to, for example, the mechanical arrangement of the components (e.g., data relating to gear ratios (e.g., opinion ratio, motor gear ratio(s), etc.) that is stored in a suitable memory device to determine the force. The force may be sampled in accordance with a predetermined semolina rate (e.g., 20 ms) and if a variation (and in an embodiment, a repeated variation) in the force is detected that is more than a certain amount (e.g., 200 N, for example), then it can be determined that the road surface is rough.

Accordingly, it will be appreciated that road surface roughness may be determined in general, and determined by controller 35, in particular, in a number of ways, and as such, the present invention is not intended to be limited to any particular way(s) of doing so.

In an embodiment, controller 35 comprises a steering assistance controller (e.g., a controller of an EPAS system) that is configured to performer the above-described assistive torque, oscillatory feedback, and road surface characterization functions. It will be appreciated that in other embodiments, controller 36 could be further programmed to perform other known control functions within the vehicle, e.g., those of the electronic vehicle control unit 39. Alternatively, another component of vehicle 4 (e.g., electronic vehicle control unit 39 or one or more dedicated controllers) may be configured to carry out or perform some or all of the oscillatory feedback and/or road surface characterization functions, to the extent that controller 35 is not also configured to do so. Accordingly, controller 35 may thus be implemented as a shared controller of vehicle 4 or as a dedicated controller.

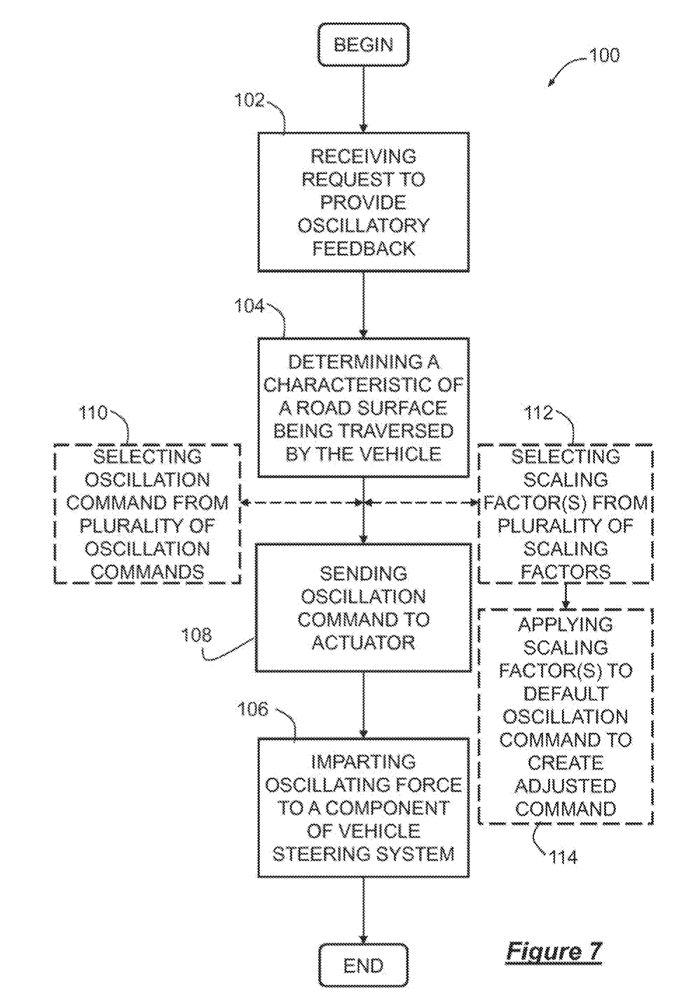

Turning now to FIG. 7, there is shown an example of a method 100 of providing oscillatory feedback through a steering system of a vehicle. It will be appreciated that while method 100 will be described in the context of vehicle 4 described above and illustrated in FIGS. 1-3, and steering system 2 and controller 35 thereof, in particular, application of the methodology is not meant to be limited solely to such an arrangement. Rather, method 100 may find application with any number of arrangements (i.e., the steps of method 100 may be performed by systems or components of vehicle 4 other than that or those described herein, or vehicle arrangements (e.g., steering systems, oscillatory feedback systems, etc.) other than that or those described above (e.g., those oscillatory feedback systems briefly described in the Background section above)). Additionally, it will be appreciated that unless otherwise noted, the performance of method 100 is not meant to be limited to any one particular order or sequence of steps or to any particular component(s) for performing the steps.

In the embodiment illustrated in FIG. 7, method 100 comprises a step 102 or receiving a request to provide oscillatory feedback through the steering system of the vehicle (e.g., steering system 2 of vehicle 4). A description of such a request including the different forms it may take and the different sources from which it may be received is set forth above and will not be repeated; rather, it is incorporated here by reference. In an embodiment, the request is received by controller 35 of steering system 2. More particularly, the request may be received at an electrical input of controller 35.

Method 100 further comprises a step 104 of determining a characteristic of a road surface being traversed by the vehicle. In an embodiment, the road surface characteristic that is determined in step 104 comprises a road surface roughness or road roughness characteristic that is indicative of a surface roughness of the road surface being traversed. Descriptions of various ways of determining road surface roughness are set forth above, and such descriptions will not be repeated but rather are incorporated here by reference. In an embodiment, road surface roughness may be determined in step 104 using one or more of those ways described above, or using any other suitable way or technique known in the art. In an embodiment, the road surface roughness may be determined by controller 35 of steering system 2.

Once the road surface characteristic (e.g., surface roughness) is determined in step 104, method 100 may proceed to a step 106 of imparting (or causing to be imparted) to a component of steering system 2 an oscillating force having one or more oscillation properties that is/are dependent upon the determined road surface characteristic. In an embodiment, the oscillatory force may be imparted to a component of the steering system 2 that is distal of one or both of steering column 6 and steering wheel 8, for example, rack 12; while in other embodiments, the force may be imparted directly to a component between rack 12 and steering wheel 8, including directly to steering column 6 and/or steering wheel 8.

Additionally, the one or more oscillating properties of the imparted oscillating force that is/are dependent upon the determined road surface characteristic may comprise one or combination of oscillation properties, including, but certainly not limited to, one or more of the frequency, amplitude, and duration of the oscillation force. In an illustrative embodiment, however, the one or more properties comprise the amplitude of the oscillation force.

In an embodiment, step 106 comprises imparting or applying the oscillating force to the steering system component via an appropriately configured and arranged actuator, for example, motor 18 under the control ol, for example, controller 35. In at least some embodiments or implementations, step 106 may optionally comprise ramping in and/or ramping out the imparted oscillating force so as to avoid abrupt application and/or removal of the oscillating force in favour of a more gradual and smooth application and/or removal of the force. In an embodiment, controller 35 may be configured to effectuate the ramping in and/or ramping out of the oscillatory force.

Depending on the implementation, method 100 may include one or more additional steps that may be performed prior to the performance of 106, and one or more of which may be optional.

For example, in an embodiment, method 100 comprises a step 108 of sending an oscillation command to the actuator (e.g., motor 18) configured to impart the oscillatory force to the steering system component in step 106. In such an embodiment, step 108 may be performed by controller 35, which, as described above, may comprise a controller of an EPAS system.

Method 100 may also include a step 110 of selecting an oscillation command from a plurality of oscillation commands in dependence on the road surface characteristic determined in step 104; and in such an embodiment, step 106 may comprise imparting the oscillation force to the component of the steering system in accordance with the selected oscillation command. Step 110 may be performed in a number of ways. In an illustrative embodiment, step 110 may comprise using the road surface characteristic determined in step 104 with an empirically-derived data structure, for example, a look-up table, model, profile, curve, etc., that maps road surface characteristics (e.g., surface roughness) (input) to oscillation commands (output) to select the appropriate oscillation command. Accordingly, in an embodiment, step 110 may comprise looking up the road surface characteristic determined in step 104 (e.g., “smooth road surface” or “rough road surface”, or a value of a parameter indicative thereof) in an appropriately configured data structure stored in a memory of or accessible by, for example, controller 35 (e.g., memory device 37), which may be configured to perform step 110, and selecting the oscillation command corresponding to that particular characteristic.

Method 100 may alternatively include a step 112 of selecting one or more scaling factors from a plurality of scaling factors in dependence upon the road surface characteristic determined in step 104, and a step 114 of applying the selected scaling factor(s) to a predetermined oscillation command, which could be a default oscillation command and referred to hereafter as such, to create an adjusted oscillation command. In an embodiment, both step 112 and step 114 may be performed by controller 35. In an embodiment wherein method 100 includes steps 112, 114, step 106 may comprise imparting the oscillating force to the component of the steering system in accordance with the -adjusted oscillation command.

Step 112 may be performed in a number of ways. In an illustrative embodiment, step 112 may comprise using the road surface characteristic determined in step 104 with an empirically-derived data structure, for example, look-up table, model, profile, curve, etc., that maps road surface characteristics (e.g., surface roughness) (input) to scaling factors (output) to select the appropriate scaling factor(s). Accordingly, in an embodiment, step 112 may comprise looking up the road surface characteristic determined in step 104 (e.g., “smooth road surface” or “rough road surface”, or a value of a parameter indicative thereof) in an appropriately configured data structure stored in a memory of or accessible by controller 35 (e.g., memory device 37), and selecting the scaling factor(s) corresponding to that particular characteristic.

As described elsewhere above, a scaling factor selected in step 112 may relate to a specific oscillation property of an oscillating force. In such an embodiment, the scaling factor selected in step 112 may be applied to a value of that particular properly in the default oscillation command. For example, if the selected scaling factor corresponds to the amplitude oscillation property, then the scaling factor may be applied to the value of the amplitude in the default oscillation command (e.g., the amplitude in the default command may be multiplied by the scaling factor). Additionally, step 112 may comprise selecting a plurality of scaling factors each of which may correspond to a respective pulse in an embodiment wherein the oscillatory feedback comprises a sequence of pulses; or two or more of may correspond to different oscillation properties.

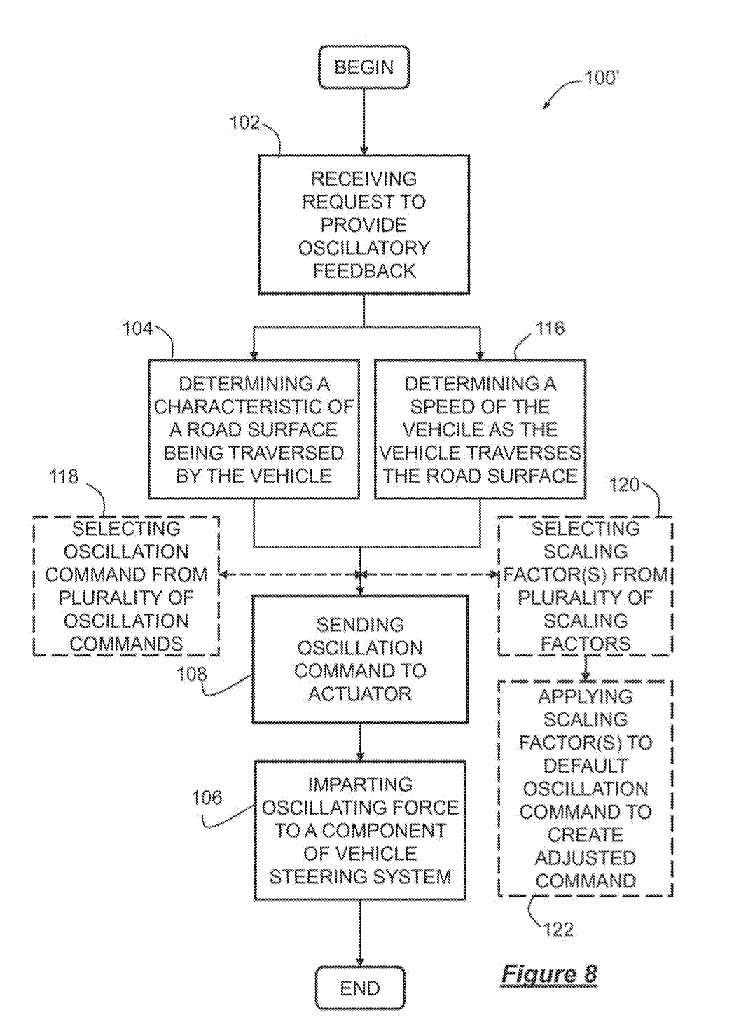

While the description of method 100 has thus far been with respect to taking into account a road surface characteristic in the provision of oscillatory feedback, in other embodiments, one or more other conditions may be additionally or alternatively taken into account. One such condition is vehicle speedy. Accordingly, in an embodiment such as that illustrated in FIG. 8, method 100 (method 100′) comprises a step 116 of determining a speed of the vehicle as the vehicle traverses the road surface, and step 106 comprises imparting an oscillating force having one or more oscillation properties that is/are dependent on one or both of the road surface characteristic determined in step 104 and the vehicle speed determined in step 116.

The vehicle speed may be determined in step 116 in any number of ways known in the art. For example, one or more electrical signals each representative of a vehicle speed value or a value of other parameter that may be used to derive the vehicle speed may be received from one or more sensors (e.g., wheel speed sensor(s)) or components of vehicle 4 (e.g., vehicle control unit 39) and may be used to determine the vehicle speed. In any event, in an embodiment, step 116 may be performed by controller 35.

In an embodiment wherein vehicle speed is taken into account, and thus, method 100′ includes step 116, method 100′ may also include a step 118 of selecting an oscillation command from a plurality of oscillation commands in dependence on the road surface characteristic determined in step 104 and/or vehicle speed determined in step 116; and in such an embodiment, step 106 may comprise imparting (or causing to be imparted) the oscillation force to the component of the steering system in accordance with the selected oscillation command.

As with step 110 described above, step 118 may be performed in a number of ways. In an illustrative embodiment, step 118 may comprise using the road surface characteristic determined in step 104 and/or vehicle speed determined in step 116 with an empirically-derived data structure, for example, a look-up table, model, profile, curve, etc., that maps road surface characteristics (e.g., surface roughness) and/or vehicle speed (input(s)) to oscillation commands (output) to select the appropriate oscillation command. Accordingly, in an embodiment, step 118 may comprise looking up the road surface characteristic determined in step 104 and/or vehicle speed determined in step 116 in an appropriately configured data structure stored in a memory of or accessible by, for example, controller 35 (e.g., memory device 37), which may be configured to perform step 118, and selecting the oscillation command corresponding to that particular characteristic and/or speed.

As shown in FIG. 8, method 100′ may alternatively include a step 120 of selecting one or more scaling factors from a plurality of scaling factors in dependence upon the road surface characteristic determined in step 104 and/or vehicle speed determined in step 116, and a step 122 of applying the selected scaling factor(s) to a default oscillation command to create an adjusted oscillation command. In an embodiment, both step 120 and step 122 may be performed by controller 35. In an embodiment wherein method 100′ includes steps 120, 122, step 106 may comprise imparting the oscillating force to the component of the steering system in accordance with the adjusted oscillation command.

Step 120 may be performed in a number of ways. In an illustrative embodiment, step 120 may comprise using the road surface characteristic determined in step 104 and/or vehicle speed determined in step 116 with an empirically-derived data structure, for example, a look-up table, model, profile, curve, etc., that maps road surface characteristics (e.g., surface roughness) and/or vehicle speed (input(s)) to scaling factors (output) to select the appropriate scaling factor(s). Accordingly, in an embodiment, step 120 may comprise looking up the road surface characteristic determined in step 104 and/or vehicle speed determined in step 116 in an appropriately configured data structure stored in a memory of or accessible by controller 35 (e.g., memory device 37), and selecting the scaling factor(s) corresponding to that particular characteristic and/or speed.

As described elsewhere above, for example, with respect to step 112, a scaling factor selected in step 120 may relate to a specific oscillation property of an oscillating force. In such an embodiment, the scaling factor selected in step 120 may be applied to a value of that particular property in the default oscillation command. For example, if the selected scaling factor corresponds to the amplitude oscillation property, then the scaling factor may be applied to the value of the amplitude in the default oscillation command (e.g., the amplitude in the default command may be multiplied by the scaling factor). Additionally, step 120 may comprise selecting a plurality of scaling factors each of which may correspond to a respective pulse in an embodiment wherein the oscillatory feedback comprises a sequence of pulses; or two or more of which may correspond to different oscillation properties.

Accordingly, it will be appreciated in view of the foregoing that while road surface characteristic(s) may be taken into account in the provision of oscillatory feedback, other conditions may be used in addition to or in lieu of road surface characteristic(s).

It will be understood that the embodiments described above are given by way of example only and are not intended to limit the invention, the scope of which is defined in the appended claims. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims. Additionally, features, characteristics, or aspects described in conjunction with one embodiment are to be understood to be applicable to any other embodiment described herein unless incompatible therewith.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Further, the terms “comprise” and “contain” and variations thereof, for example “comprising” and “comprises”, mean “including but not limited to”, and are not intended to and do not, exclude other possibilities not expressly provided for herein. Moreover the singular encompasses the plural unless the context otherwise requires: in particular, where the indefinite article is used, the specification is to be understood as contemplating plurality as well as singularity, unless the context requires otherwise. Other terms are to be construed using their broadest reasonable meaning unless they are used in a context that requires a different interpretation.

1. A method of providing oscillatory feedback through a steering system of a vehicle, comprising:
receiving a request to provide oscillatory feedback through the steering system of the vehicle;
determining a characteristic of a road surface being traversed by the vehicle;
selecting an oscillation command from a plurality of oscillation commands in dependence on the determined road surface characteristic;
the selecting step comprising using the determined road surface characteristic and a look up table that maps road surface characteristics (input) to oscillation commands (output) to select the oscillation command; and
imparting to a component of the steering system an oscillating force having one or more oscillation properties that is/are dependent upon the determined road surface characteristic,
wherein the imparting step comprises imparting the oscillating force to the component of the steering system in accordance with the selected oscillation command.

2-3. (canceled)

4. The method of claim 1, whereinafter the road surface characteristic is determined, the method comprises:
selecting a scaling factor from a plurality of scaling factors in dependence on the determined road surface characteristic; and
applying the scaling factor to an oscillation command to create an adjusted oscillation command, wherein
the imparting step comprises imparting the oscillating force to the component of the steering system in accordance with the adjusted oscillation command, and wherein the selecting step comprises using the determined road surface characteristic and a look up table that maps road surface characteristics (input) to scaling factors (output) to select the scaling factor.

5. (canceled)

6. The method of claim 1, wherein the determining step comprises one of:
receiving one or more electrical signals representative of the road surface characteristic, or
receiving one or more electrical signals each representative of a value of a vehicle-related parameter and deriving the road surface characteristic from the received parameter value(s).

7. (canceled)

8. The method of claim 1, wherein:
the road surface characteristic comprises a surface roughness of the road surface being traversed, and/or
the one or more oscillation properties that is/are dependent upon the determined road surface characteristic comprises an amplitude of the oscillating force.

9. (canceled)

10. The method of claim 1, comprising at least one of:
determining a speed of the vehicle as the vehicle traverses the road surface, and further wherein the imparting step comprises imparting an oscillating force having one or more oscillation properties that is/are dependent upon both the determined road surface characteristic and the determined vehicle speed, and
sending an oscillation command to an actuator to perform the imparting step, wherein the sending step is performed by an electronic controller of an electric power assisted steering (EPAS) system.

11. The method of claim 1, wherein the imparting step comprises ramping in the oscillating force, ramping out the oscillating force, or both.

12-13. (canceled)

14. A non-transitory, computer-readable storage medium storing instructions thereon that when executed by one or more electronic processors causes the one or more electronic processors to carry out the method of claim 1.

15. A system for providing oscillatory feedback through a steering system of a vehicle, comprising:
means for receiving a request to provide oscillatory feedback through the steering system of the vehicle;
means for determining a characteristic of a road surface being traversed by the vehicle;
means to select an oscillation command from a plurality of oscillation commands in dependence on the determined road surface and characteristic,
wherein selecting the oscillation command comprises using the determined road surface characteristic and a look-up table that maps road surface characteristics (input) against oscillation commands (output) to select the oscillation command; and
means for causing an oscillating force to be imparted to a component of the steering system having one or more oscillation properties that is/are dependent upon the determined road surface characteristic in accordance with the selected oscillation command.

16. The system of claim 15, wherein the receiving, determining, and causing means comprise:
an electronic processor having one or more electrical inputs; and
an electronic memory device electrically coupled to the electronic processor and having instructions stored therein,
wherein the electronic processor is configured to access the memory device and execute the instructions stored therein such that it is configured to:
receive the request to provide oscillatory feedback;
determine the characteristic of the road surface; and
cause the oscillating force to be imparted to the component of the steering system.

17-18. (canceled)

19. The system of claim 16, wherein the electronic processor is configured to:
select a scaling factor from a plurality of scaling factors in dependence on the determined road surface characteristic;
apply the scaling factor to an oscillation command to create an adjusted oscillation command, and
impart the oscillating force to the component of the steering system in accordance with the adjusted oscillation command, and wherein
selecting the scaling factor may comprise using the determined road surface characteristic and a look-up table that maps road surface characteristics (input) against scaling factors (output) to select the scaling factor.

20. (canceled)

21. The system of claim 16, wherein the electronic processor is configured to determine a speed of the vehicle as the vehicle traverses the road surface, and to cause an oscillating force to be imparted to the component of the steering system having one or more properties that is/are dependent upon both the determined road surface characteristic and the determined vehicle speed.

22. The system of claim 15, wherein causing the oscillating force to be imparted comprises ramping in oscillating force, ramping out the oscillating force, or both.

23. The system of claim 15, wherein determining the characteristic of the road surface comprises at least one of:
receiving one or more electrical signals representative of the road surface characteristic, or
receiving one or more electrical signals each representative of a value of a vehicle-related parameter; and
deriving the road surface characteristic from the received parameter value(s).

24. (canceled)

25. The system of claim 15, wherein the road surface characteristic comprises a surface roughness of the road surface being traversed.

26. The system of claim 15, wherein the one or more oscillation properties that is/are dependent upon the determined road surface characteristic comprises an amplitude of the oscillating force.

27. The system of claim 15, wherein causing the oscillating force to be imparted to the component of the steering system comprises sending the oscillation command to an actuator configured to impart the oscillating force to the steering system component.

28. An electronic controller for a vehicle having a storage medium associated therewith storing instructions therein that when executed by the controller causes the provision of oscillatory feedback through a steering system of the vehicle in accordance with the method of:
receiving a request to provide oscillatory feedback through the steering system of the vehicle;
determining a characteristic of a road surface being traversed by the vehicle; *Hill
selecting an oscillation command from a plurality of oscillation commands in dependence on the determined road surface characteristic;
the selecting step comprising using the determined road surface characteristic and a look up table that maps road surface characteristics (input) to oscillation commands (output) to select the oscillation command; and
imparting to a component of the steering system an oscillating force having one or more oscillation properties that is/are dependent upon the determined road surface characteristic in accordance with the selected oscillation command.

29. A vehicle comprising the system of claim 15.

30. A vehicle steering system comprising the system of claim 15.

31. An electric power assisted steering system for a vehicle comprising the system of claim 15.

32. (canceled)
